(19) United States
(12) Patent Application Publication
(10) Pub. No.: US 2026/0285747 A1
(43) Pub. Date: Sep. 24, 2026

(54) SOLAR CONTROL LAMINATED GLAZING

(71) Applicant: AGC GLASS EUROPE, Louvain-la-Neuve (BE)

(72) Inventor: Kadosa HEVESI, Gosselies (BE)

(73) Assignee: AGC GLASS EUROPE, Louvain-la-Neuve (BE)

(21) Appl. No.: 19/475,776

(22) PCT Filed: Jul. 1, 2024
(86) PCT No.: PCT/EP2024/068441

§ 371 Date: Oct. 16, 2025

(30) Foreign Application Priority Data
Jul. 4, 2023 (EP) 23183290.8

(51) Int. Cl. C03C 17/36; B32B 17/10; E06B 9/24

(52) U.S. Cl. CPC C03C 17/366; B32B 17/10036; B32B 17/10211; B32B 17/10229; C03C 17/3626; C03C 17/3644; C03C 17/3649; E06B 9/24; C03C 2217/212; C03C 2217/216; C03C 2217/23; C03C 2217/252; C03C 2217/256; C03C 2217/258; C03C 2217/281; C03C 2218/156; E06B 2009/2417

(57) ABSTRACT

The present invention concerns a laminated solar control glazing comprising an outer glass pane (1) and an inner glass pane (4), united by a thermoplastic intercalating sheet (3) and a solar control coating (2) applied to at least part of the inside face of the outer glass, the solar control coating (2) being such that the exterior visible light reflectance of the laminated solar control glazing RLext is at least 35% and the exterior solar energy reflectance of the laminated solar control glazing REext is at least 45%.

### TECHNICAL FIELD

The present invention relates to laminated glazing comprising a solar control coating and having a particularly low solar energy transmission. The present invention in particular relates to such a solar control laminated glazing having a high external visible light reflectance and external solar energy reflectance.

The present invention also relates to such a solar control laminated glazing further comprising a low emissivity insulating coating on the innermost face of the laminated glazing.

### BACKGROUND ART

Laminated glazing is used in many ways and in many applications, mainly in motor vehicles, but also in buildings as safety glazing and has been known for a long time. Laminated glazing may also be configured as solar control glazing having low total solar energy transmittance. During the use of laminated glazing with a solar control coating, it is necessary for this coating to be protected inside the lamination, since the solar control coatings manufactured by magnetron sputtering at the present time are not resistant to bad weather or to mechanical attack.

For some solar control laminated glazing a relatively high light transmittance is sought after with low total solar transmittance. However for motor vehicles having a large surface area of glass for example, the heating inside the driving compartments is reduced by using low visible light transmittance laminated glass panes which have a solar control function. The passengers' comfort is thus increased and, in addition, savings can be made in the energy costs, weight and manufacturing costs: the ventilation and air conditioning units usually used can be dimensioned so as to be of smaller power. Laminated glass panes are used in particular for side window panes, rear windows and sunroofs. In these cases, the glazing may typically be equipped with a coating which mainly reflects and/or absorbs the infrared rays. Using solar control laminated glass panes effectively prevents excessive heating of the interior of the driving compartments in a quite satisfactory manner, even when the motor vehicle has a large surface area of glass.

In solar control laminated glazings of the prior art the total solar transmittance can only be lowered enough by increasing absorption. Absorption in the visible and/or infrared wavelengths may be increased be the use of colored glass and/or thermoplastic intercalating sheets that are strongly light absorbing or by using solar control coatings that are strongly light absorbing. Even then, it was found that the total solar transmittance could not be lowered below 10%.

EP1765588A1 discloses for a laminated glazing for a vehicle roof various examples comprising solar control coatings on the inner side of the outer glass pane and some examples additionally bearing a low emissivity coating on the inner side of the inner glass pane. However in all those examples, the total solar energy transmittance (solar factor) remains always above 30%.

WO2019110172A1 a laminated glazing for a vehicle roof comprising solar control coatings on the inner side of the outer glass pane and bearing a low emissivity coating on the inner side of the inner glass pane. A total solar energy transmittance (solar factor) is obtained for low visible light transmittance and reflectance levels, meaning that light absorption is high. At high visible light absorption, a large part of solar radiation is absorbed and then re-emitted inwards, limiting thus how far the total solar transmittance level of these glazings can be lowered.

### SUMMARY OF INVENTION

It is an object of the present invention to provide an improved laminated glazing with solar control properties, such that the total solar transmittance (g) is significantly reduced.

The laminated glazing may be provided in a window opening to separate an interior space, in particular the interior space of a vehicle or a building, from the external environment. The laminated glazing comprises a first, outer, glass pane and a second, inner, glass pane, united by a thermoplastic intercalating sheet (3). For the purpose of the present invention, the term inner glass pane (4) denotes the pane facing the interior space in the installed position and the outer pane is referred to as the pane facing the external environment in the installed position. In the context of the present invention, the surface on the inside or inside surface of a pane is understood to mean that surface of that pane which, in the installed position, faces towards the interior. In the context of the invention, the outside surface of a pane, is understood to mean that surface of the pane which in the installed position, faces towards the external environment. According to common practice in the field, the faces of the inner (4) and outer (1) glass panes are numbered from 1 to 4, as is usual in the art, starting on the outside surface of the outer pane (surface 1). The inside surface of the outer pane is numbered surface 2, the outside surface of the inner pane is numbered surface 3 and the inside surface of the inner pane is numbered surface 4.

The aim of the present invention is achieved by the subject of claim 1 and the claims which follow. The inventors have indeed found that the total solar transmittance of a solar control laminated glazing comprising an outer glass pane (1) and an inner glass pane (4), united by a thermoplastic intercalating sheet (3) (thermoplastic intercalating sheet (3)) and a solar control coating (2) applied to at least part of the inside face of the outer glass, can be significantly reduced by providing a solar control coating (2) being such that the exterior visible light reflectance of the laminated solar control glazing RLext is at least 35% and the exterior solar energy reflectance of the laminated solar control glazing REext is at least 45%.

The optical properties of the solar control coated outer glass pane (1) alone may change dramatically when it is laminated to the inner glass pane (4). Therefor the optical characteristics have to be evaluated on the laminated glazing.

By enabling such visible light and solar energy reflectance levels, the inventors have found that particularly low total solar energy transmittance levels could be reached in the laminated solar control glazing.

The present invention thus concerns a laminated solar control glazing comprising
a. an outer glass pane (1) and an inner glass pane (4), united by a thermoplastic intercalating sheet (3) and
b. a solar control coating (2) applied to at least part of the inside face of the outer glass,
c. the solar control coating (2) being such that the exterior visible light reflectance of the laminated solar control glazing RLext is at least 35% and the exterior solar energy reflectance of the laminated solar control glazing REext is at least 45%.

The inventors have found that laminated solar control glazing with low total solar energy transmittance can be obtained.

[high LT variant] In a high visible transmittance embodiment of the present invention, the laminated solar control glazing has a visible light transmittance LT of at least 40% and total solar energy transmittance g of not more than 0.450. LT of at least 40% is in particular of interest for certain building application for example where sufficient through-vision is desirable. In particular LT may be <55%, to limit glare inside the building. Advantageously g may be less than 0.400, less than 0.350 or even less than 0.300 with LT less than 50%. More advantageously g may be less than 0.300 with LT being less than 45%.

[low LT variant] In a low visible transmittance embodiment of the present invention, the laminated solar control glazing has a total solar energy transmittance g of not more than 0.130 and visible light transmittance LT ranging from 1% to 10%. Such optoenergetical properties, in particular low LT, may be achieved by different means, that work in combination with the high level of RLext. In particular the laminated solar control glazing may comprise a light absorbing thermoplastic intercalating sheet (3) or a light absorbing inner glass pane (4). Alternately the solar control coating (2) may comprise a light absorbing layer.

In an embodiment of the present invention the outer and/or inner glass panes are heat treated, in particular heat strengthened, tempered and/or bended.

In an embodiment of the present invention, the laminated solar control glazing may have an external visible light reflectance RLext of at least 37%, advantageously at least 40%, more advantageously at least 41%. At higher visible light reflectance levels, lower g values may be obtained.

In an embodiment of the present invention, the laminated solar control glazing may have an external visible light reflectance RLext of at most 70%, advantageously at most 55%, more advantageously at most 50%. If the external visible light reflectance is too high, it may be perceived as unpleasant or blinding by passers-by or other vehicle operators.

In an embodiment of the present invention, the laminated solar control glazing may have an external solar energy reflectance REext of at least 50%, advantageously at least 55%, At higher solar energy reflectance levels, lower g values may be obtained.

In an embodiment of the present invention, the laminated solar control glazing may have an external solar energy reflectance REext of at most 80%, advantageously at most 65%, more advantageously at most 60%.

In an embodiment of the present invention, in particular a low visible transmittance embodiment of the present invention, the laminated solar control glazing may possess a visible light transmittance TL of not more than 8%, preferably not more than 6%, more preferably not more than 4% or even not more than 3.5%. Further, TL may be at least 1% advantageously at least 3%. Such visible light transmittance levels provide a sufficient view through the glazing while limiting the amount of glare to an observer positioned behind the glazing.

In an embodiment of the present invention, in particular a low visible transmittance embodiment of the present invention, the laminated solar control glazing is formed in such a way that it possesses a total solar energy transmittance g of not more than 0.120, advantageously not more than 0.110, more advantageously not more than 0.100, even more advantageously not more than 0.095, even more advantageously not more 0.090.

In an embodiment of the present invention, in particular a low visible transmittance embodiment of the present invention, the laminated solar control glazing is formed in such a way that it is devoid of any coating on the interior face and possesses a total solar energy transmittance g ranging from 0.200 to 0.500, advantageously from 0.250 to 0.450, even more advantageously from 0.260 to 0.420.

In an embodiment of the present invention, in particular a low visible transmittance embodiment of the present invention, the laminated solar control glazing comprises a low emissivity coating (5) on the inner face of the second pane. Thus, in addition to the increased solar control function, a heat-insulating function is obtained. Indeed, with increasing the solar control function of a laminated glazing in vehicles for example, such glass may be perceived as uncomfortably cold, in particular under cool weather conditions. The inventors have found that providing a low emissivity (lowE) coating on the internal face of the laminated glazing reduces the perception of cold in winter but may also, to further improve solar control properties at high outside temperatures in the summer, reduces the emission of thermal radiation from the glazing into the interior, thus reducing the solar radiation transmittance.

It is noted that the invention relates to all possible combinations of features recited in the claims.

### BRIEF DESCRIPTION OF DRAWINGS

These and further aspects of the invention will be explained in greater detail by way of example and with reference to the accompanying drawings in which:

FIG. 1 shows a schematic representation of a laminated glazing according to an embodiment of the present invention.

### DESCRIPTION OF EMBODIMENTS

Here within, light reflectance, external (LRext) and internal (LRint), and light transmittance (LT) are determined according to standard ISO9050 (2003) with illuminant A and 2° observer angle. Solar energy transmittance, and solar energy reflectance, external (ERext) and internal (ERint), are determined according to standard ISO9050. As defined in the standards used, visible light reflectance and transmittance concerns the visible wavelengths only. Solar energy reflectance and transmittance concern the whole solar wavelength range, thus include visible and infrared wavelengths. Total solar energy transmittance in particular also comprises radiation that is absorbed and reemitted in the infrared wavelength range. Total solar transmittance or solar factor (TTS, SF or g) is the percentage of incident energy radiation that is directly transmitted by the glazing, on the one hand, and absorbed by this, then radiated in the opposite direction to the energy source in relation to the glazing. It is here calculated in accordance with standard ISO13837 (2021) with wind velocity=0 km/h.

External reflectance, light or solar energy reflectance, of a laminated glazing is measured on its outside surface, internal reflectance is measured on its inside surface. Inside and outside referring to the intended installation position of the glazing. External reflectance of a laminated glazing of the present invention is measured on the outside surface of its outer pane, internal reflectance is measured in the inside surface of its inner pane. As is customary in the glazing world, the glass sheets are numbered starting at the glass sheet in contact with the exterior and moving towards the interior. Furthermore, the faces of the glass sheets are numbered starting from the face of the first glass sheet, in contact with the exterior and moving inwards. Each pane having two faces, the outer face of the outer pane refers to face number 1, the inner face of the outer pane refers to face number 2, the outer face of the inner pane refers to face number 3 and the inner face of the inner pane refers to face number 4.

The emissivity (E) is calculated in accordance with standards EN673 and ISO 10292.

The CIELAB 1976 values (L*,a*,b*) are used to define the tints. They are measured with illuminant D65/10°.

Here within, when values are referred to as “in the range of between a and b” or “ranging from a to b”, they may be equal to a or b.

For the sake of clarity, when using terms like “bottom”, “top”, “below”, “above”, “lower”, “upper”, “first” or “last” herein, it is always in the context of a sequence of layers starting from the pane surface below, going upward, further away from the glass. Such sequences may comprise additional intermediate layers, in between the defined layers, except when a direct contact is specified.

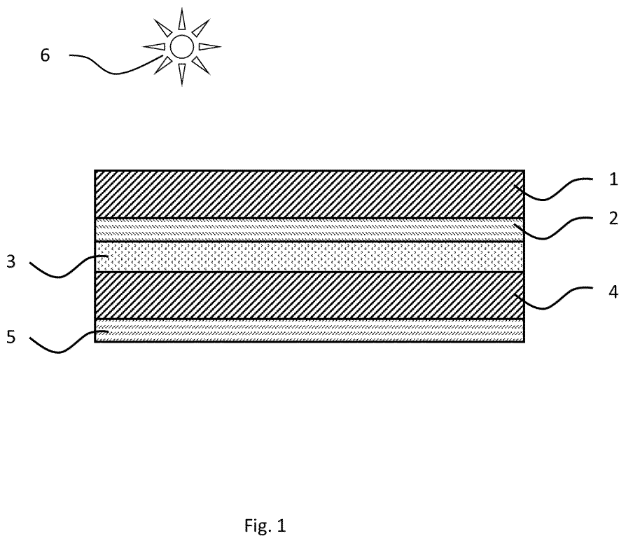

FIG. 1 shows a laminated glazing according to an embodiment of the present invention. An outer glass pane (1) and an inner glass pane (4), united by a thermoplastic intercalating sheet (3) and a solar control coating (2) applied to at least part of the inside face of the outer glass pane (1). An optional low emissivity (lowE) coating (5) on the internal face of the laminated glazing. The laminated glazing of the present invention provides for a high reflectance of radiation from the sun (6), thus reaching lower total solar energy transmittance.

The solar control coating (2) of a laminated solar control glazing of the present invention, is provided on the second face of the laminated glazing. It was found that thereby the incoming sunlight may be reflected before attaining the intercalating thermoplastic sheet and the second glass sheet, thus limiting the amount of radiation from the sun that is transmitted but also limiting the amount of radiation that is absorbed, and thus re-emitted inwards.

In order to obtain the desired opto-energetical properties, the solar control coating (2) may comprise an alternating arrangement of n infrared radiation reflecting functional layers (functional layers) and n+1 dielectric coatings, with n≥1, such that each functional layer is surrounded by dielectric coatings.

In such solar control coatings (2), the infrared reflecting functional layers preferably comprise or consist of silver. When the infrared reflecting functional layer is said to comprise silver, it is intended to mean, for example, alloys of silver, with other metal elements, such as palladium, platinum, cupper or gold, at up to 10% wt of the alloy.

In such solar control coatings (2), the dielectric coatings may comprise one or more layers comprising
a. oxides of Bi, Hf, In, Mg, Nb, Ni, Sb, Sn, Ti, W, Y, Zn, Zr, Al, Si or mixtures thereof, in particular mixtures of oxides of In and Sn, Zn and Sn, Zn and Ti, Ti and Zr, Ti and Si, Ti and Nb, Zr and B, Ga and Zn, Zn and Al, Tl and Zr and Si, Ti and Zr and Al, or Ti and Zr and Al and Y, any oxides being optionally doped with Al, B, F, or Ga, In, Si, Sb, Sn, Sb,
b. nitrides of Al, Cr, Si, Ta, Ti, Zr or mixtures thereof, in particular mixtures of nitrides of Si and Zr or Si and Ta, any nitrides being optionally doped with Al, Cr, Ni, or Z.
c. oxynitrides or oxycarbides of Si.

In such solar control coatings (2), the dielectric coatings may in particular comprise one or more layers of metal oxide for example of the type SnO₂, ZnO, Nb₂O₅, TiO₂, Ta₂O₅ or SiO₂ or mixed oxides, or layers of mixed oxides for example of zinc and tin or of titanium and zirconium or of silicon and zirconium or layers of nitride for example of the type AlN, Si₃N₄, or SiZrN.

In addition, the dielectric coatings may comprise over and/or under each of the infrared reflecting functional layers there may be thin layers of an optionally partially oxidized metal, which are intended to serve as nucleation layers or sacrificial layers. They may be made of Sn, Zn, Ti, Ni, Cr, NiCr, Nb, etc.

In a preferred embodiment, over and/or under each functional layer there is a layer comprising zinc oxide, optionally doped with aluminum or mixed with tin oxide which are intended to serve as nucleation layers or barrier layers. Such seed/barrier layers are preferred among others as they provide lower absorption levels than optionally partially oxidized metal layers. Such seed layers are particularly useful to improve the quality of overlying infrared reflecting functional layers, in particular of silver.

Preferred nucleation layers include Ti, NiCr, zinc oxide, optionally doped with aluminum or zinc oxide mixed with tin oxide, such as discussed above.

According to an embodiment of the present invention, the solar control coating (2) comprises a single functional layer. Such coatings may be economically advantageous to produce.

According to an embodiment of the present invention, the solar control coating (2) comprises, starting from the glass pane, a first dielectric coating, a first, single, functional layer and a second dielectric coating.

According to an embodiment of the present invention, the solar control coating (2) comprises two functional layers. Such solar control coatings (2) may provide for better opto-energetical properties than single functional layer solar control coatings (2), while still being reasonably economical to produce. Such a solar control coating (2) thus comprises, in sequence starting from the glass pane, a first dielectric coating, a first functional layer, a second dielectric coating, a second functional layer and a third dielectric coating.

According to an embodiment of the present invention, the solar control coating (2) comprises three functional layers. Such solar control coatings (2) may provide the best opto-energetical properties, while being more expensive to produce than single or double functional layer solar control coatings (2). Such a solar control coating (2) may thus comprise, in sequence starting from the glass pane, a first dielectric coating, a first functional layer, a second dielectric coating, a second functional layer, a third dielectric coating, a third functional layer and a fourth dielectric coating.

According to an embodiment of the present invention the solar control coating (2) comprises in the topmost dielectric coating a toplayer. Such a toplayer, being the topmost layer in the solar control coating (2), provides in particular mechanical protection to the stack of layers.

According to an embodiment of the present invention the sum of the physical thicknesses of the n functional layers of the solar control coating (2) is at least 19 nm.

According to an embodiment of the present invention the sum of the physical thicknesses of the n functional layers of the solar control coating (2), in particular comprising two or more functional layers, is at least 25 nm, preferably at least 30 nm, more preferably at least 35 nm. It was found that for higher combined functional layer thicknesses the total solar energy transmittance was lower.

According to an embodiment of the present invention the sum of the physical thicknesses of the n functional layers of the solar control coating (2), in particular comprising two or more functional layers, is at most 65 nm, advantageously at most 50 nm, or even at most 45 nm. It was found that when the functional layer thicknesses were too high visible light absorption started increasing.

According to an embodiment of the present invention the dielectric coatings of the solar control coating (2) comprise zinc oxide-comprising contact layers underlying and/or overlying and in contact with each functional layer.

The material of the contact layers, underlying or overlying any functional layers in the stack of layers of the present invention, may be chosen independently among any of the following:
a. a zinc oxide doped with aluminium in a weight ratio of Zn/Al of at least 95/5, preferably at least 98/2;
b. pure ZnO (designated as iZnO);
c. zinc oxide doped with aluminium (designated as AZO) or tin in a proportion of aluminum or tin up to 10% by weight, alternately of up to 5% by weight at most, preferably of around 2% by weight.

These types of contact layers have the advantage of reducing the changes in opto-energetical properties, in particular color and transmittance, upon heat treatment.

Alternately, metal based contact layers, optionally at least partly oxidized, may be used. Compared to zinc oxide based contact layers, such metal based contact layers in particular show higher degrees of change in opto-energetical properties upon heat treatment and also need careful control of the deposition of overlying oxide and nitride layers as these lead to differing degrees of oxidation/nitration of any underlying metal layers. Compared to metal based contact layers, underlying zinc oxide based contact layers furthermore lead to more controlled growth of overlying functional layers, thereby lower functional layer thicknesses are required to reach desired degrees of Energetical Reflection (RE).

Zinc oxide based contact layers may be obtained by sputtering from a metal target of zinc, optionally doped with aluminum or tin, in an oxygen containing atmosphere. Alternately the contact layers may be obtained by sputtering a ceramic target of aluminum or tin doped zinc oxide in a non-oxidizing atmosphere. This is preferred when depositing a contact layer on a silver layer.

According to an embodiment of the present invention, the thickness of contact layers comprising zinc oxide is preferably 10 nm at most, more preferably 8 nm at most even more preferably 6 nm at most.

According to an embodiment of the present invention, the thickness of contact layers comprising zinc oxide is preferably at least 2 nm, more preferably at least 3 nm.

According to an embodiment of the present invention the solar control coating (2) comprises two functional layers. Such a solar control coating (2) thus comprises in sequence starting from the glass a first dielectric coating, a first functional layer, a second dielectric coating, a second functional layer and a third dielectric coating.

According to an embodiment of the present invention the solar control coating (2) is such that the optical thickness of the first dielectric coating is comprised between 15 and 185 nm and/or the optical thickness of the second dielectric coating is comprised between 140 and 250 nm and/or the optical thickness of the third dielectric coating is comprised between 30 and 200 nm.

The optical thickness herein is the result of the multiplication of the physical thickness of a layer of material with the refractive index of said material at a wavelength of 550 nm.

The optical thickness can be understood as the optical path length, which is what effectively matters for the light interaction with the coating. Depending on the one or more layers of material of the dielectric coating selected, their physical thicknesses can be adjusted to reach the same target optical thickness needed for achieving the present invention. The consideration of optical thicknesses thus allows for the design optimization of the optical interference system of the present solar control coating.

According to an embodiment of the present invention the solar control coating (2) is such that the sum of the optical thicknesses of the first, second and third dielectric coatings is comprised between 280 and 460 nm

According to an embodiment of the present invention the solar control coating (2) comprises two functional layers, wherein the first, second and/or third dielectric coatings comprise a layer of zinc-tin mixed oxide.

According to an embodiment of the present invention the solar control coating (2) comprises two functional layers, wherein the first dielectric coating comprises or consists of a zinc-tin oxide layer and a zinc-oxide based contact layer.

According to an embodiment of the present invention the solar control coating (2) comprises two functional layers, wherein the second dielectric coating comprises or consists of, in sequence starting from the first functional layer, a titanium sacrificial barrier layer in contact with the first functional layer, a zinc-tin mixed oxide layer and a zinc oxide based contact layer in contact with the second functional layer.

According to an embodiment of the present invention the solar control coating (2) comprises two functional layers, wherein the third dielectric coating comprises or consists of a zinc oxide based contact layer in contact with the second functional layer, a zinc-tin mixed oxide layer and a toplayer. The toplayer is the final, or topmost, layer of the solar control coating (2) having a refractive index at 550 nm wavelength of at least 1.8.

The solar control coating (2) of the present invention may comprise a protective overcoat in contact with the thermoplastic intercalating sheet (3). The protective overcoat assists in protecting the underlying layers from mechanical and chemical attack during processing, and, having a refractive index similar to the thermoplastic intercalating sheet (3), has no significant influence on the optical properties of the laminated glazing over wide ranges of thickness. Therefore such protective overcoat layers are not considered part of the topmost dielectric coating. The refractive index of the protective coating can be in the range of 1.4 to 1.8, such as 1.4 to 1.6. The thickness of the protective coating may range from 5 nm to 5000 nm, such as 5 nm to 1000 nm, such as 10 nm to 100 nm, e.g., 10 nm to 50 nm, such as 10 nm to 40 nm, such as 20 nm to 30 nm, such as 25 nm. The protective coating can include a layer having one or more metal oxide materials, such as but not limited to oxides of aluminum, silicon, or mixtures thereof.

For example, the protective coating can comprise one single layer or at least two layers of different composition, any such layer comprising in the range of 0 wt. % to 100 wt. % alumina and/or 100 wt. % to 0 wt. % silica, such as wt. % to 95 wt. % alumina and 95 wt. % to 5 wt. % silica, such as 10 wt. % to 90 wt. % alumina and 90 wt. % to 10 wt. % silica, such as 15 wt. % to 90 wt. % alumina and wt. % to 10 wt. % silica, such as 50 wt. % to 75 wt. % alumina and 50 wt. % to 25 wt. % silica, such as 50 wt. % to 70 wt. % alumina and 50 wt. % to 30 wt. % silica, such as 35 wt. % to 100 wt./0 alumina and 65 wt. % to 0 wt. % silica, e.g., 70 wt. % to 90 wt. % alumina and 30 wt. % to 10 wt. % silica, e.g., 75 wt. % to 85 wt. % alumina and 25 wt. % to 15 wt. % of silica, e.g., 88 wt. % alumina and 12 wt. % silica, e.g., 65 wt. % to 75 wt. % alumina and 35 wt. % to 25 wt. % silica, e.g., 70 wt. % alumina and 30 wt. % silica, e.g., 60 wt. % to less than 75 wt. % alumina and greater than 25 wt. % to 40 wt. % silica. Other materials, such as aluminum, chromium, hafnium, yttrium, nickel, boron, phosphorous, titanium, zirconium, and/or oxides thereof, can also be present, such as to adjust the refractive index of the protective coating.

In one non-limiting embodiment, the protective coating is a combination silica and alumina coating. The protective coating can be sputtered from two cathodes (e.g., one silicon and one aluminum) or from a single cathode containing both silicon and aluminum. This silicon/aluminum oxide protective coating can be written as SiₓAl₁₋ₓO_{1.5+x/2}, where x can vary from greater than 0 to less than 1.

Alternatively, the protective coating can be a multi-layer coating formed by separately formed layers of metal oxide materials, such as but not limited to a bilayer formed by one metal oxide-containing layer (e.g., a silica and/or alumina-containing first layer) formed over another metal oxide-containing layer (e.g., a silica and/or alumina-containing second layer). The individual layers of the multi-layer protective coating can be of any desired thickness.

In a preferred embodiment of the present invention, in any dielectric coating, the layers of zinc-tin mixed oxide are layers in which the proportion of zinc-tin is between 40-60 and 60-40% by weight (Zn₂SnO₄), e.g. 52-48 Wt. %. The zinc-tin mixed oxide may be advantageous in that it has a good deposition rate compared, for example, to SiO₂ or Al₂O₃, and/or in that it has a good chemical stability compared, for example, to pure ZnO or bismuth oxide. Moreover, it may be advantageous in that it has less tendency to generate haze after heat treatment of the stack compared, for example, to the oxides of Ti or Zr at similar thickness.

According to an embodiment of the present invention the solar control coating (2) comprises in the topmost dielectric coating a toplayer comprising a metal oxide or a metal nitride comprising titanium and/or zirconium or a mixed oxide of silicon and zirconium or a mixed nitride of silicon and zirconium. Such a layer provides in particular mechanical protection to the stack of layers. According to a preferred embodiment of the present invention, the toplayer comprises an oxide comprising titanium and/or zirconium, which provides better adhesion to the thermoplastic intercalating sheet (3).

In an advantageous embodiment of the present invention, the toplayer comprises at least TiO_{y} and ZrO₂, and optionally SiOₓ, wherein x, y, z may range from 1.8 to 2.2, wherein the toplayer may comprise
a. from 8 to 49 at % titanium,
b. from 51 to 92 at % zirconium,
c. from 0 to 9 at % silicon,
d. for a total of 100 at % of the metals, and wherein the toplayer has a thickness from 0.1 to 10 nm; to improve durability by increasing the abrasion resistance by at least 20%, alternatively by at least 30%, alternatively by at least 40%.

In some embodiments of the present use, compatible with other embodiments of the present invention, the above ranges for the Ti, Zr and Si in the toplayer may independently vary for one from the other. The amount of Ti may alternatively range from 10 to 47 at %, alternatively from 12 to 46 at %. The amount of Zr may alternatively range from 53 to 90 at %. The amount of Si may alternatively range from 1 to 8 at %, alternatively from 2 to 7 at %. These amounts may thus vary independently for each metal, provided the total is 100 at % of the metal, including impurities, as discussed above.

In an advantageous embodiment of the present invention, the metal oxide or metal nitride toplayer consists of an oxide or substoichiometric oxide of at least one element selected from Ti and Zr, more preferably of a titanium-zirconium mixed oxide, e.g. in a weight ratio of TiO_{y}/ZrO_{z} of close to 65/35. Such a layer may provide particular good chemical and/or mechanical stability of the glazing.

Traces of Yttrium may be present in any Zr containing layers of the present solar control coating (2).

In another advantageous embodiment of the present invention, the metal oxide or metal nitride toplayer consists of a mixed nitride of silicon and zirconium. Advantageously, the mixed nitride of silicon and zirconium having a Si/Zr atomic ratio of at least 1 or at least 4. Advantageously the mixed nitride of silicon and zirconium having a Si/Zr atomic ratio of at most 12 or at most 6.

In another advantageous embodiment of the present invention, the metal oxide or metal nitride toplayer consists of mixed oxide of silicon and zirconium which may comprise 5 to 50 mol % of zirconium oxide, preferably 8 to 20 mol %. The layer of mixed silicon zirconium oxide may have a geometrical thickness ranging of from 1 to 10 nm, alternatively of from 1.5 to 9 nm, alternately from 4 to 9 nm.

According to an embodiment of the present invention, the toplayer, when it comprises Ti and/or Zr, in particular oxides of Ti and/or Zr, has a geometric thickness of at least 1 nm, preferably at least 1.5 nm. Its geometric thickness is 10 nm at most, advantageously 6 nm at most. Oxides of Ti and Zr have a higher refractive index than for example SiO₂, zinc-tin oxides, silicon nitride. Too high thicknesses of such oxides may lead to undesired reflectance levels and/or colors.

According to an embodiment of the present invention laminated glazing has a RLext/TL ratio of at least 10, advantageously at least 13, more advantageously at least 15. With increasing RLext/TL ratios, the view from the outside towards the inside can be significantly reduced, thus for instance providing privacy to anybody inside a vehicle.

According to an embodiment of the present invention laminated glazing has a color in exterior reflection in the blues, in the greens or in the blue-greens. Such colors may in particular be obtained by appropriately adjusted optical thicknesses of the dielectric coatings. The color coordinates of the exterior reflection may thus be such that a*<0 and b*<0.

According to an embodiment of the present invention, the solar control coating (2) comprises one or more layers of absorbing material, in particular inserted in the dielectric coatings or inserted in between the dielectric coatings and the functional layers.

According to an alternate embodiment of the present invention, the solar control coating (2) comprises no layers of absorbing material, in particular inserted in the dielectric coatings or inserted in between the dielectric coatings and the functional layers. Layers of absorbing material are layers having extinction coefficients k such that 1.0≤k. Extinction coefficients k may in particular be less than or equal to 3.5. The extinction coefficient corresponds to the imaginary part of the refractive index. Here within, refractive indexes are considered for a wavelength of 550 nm.

The layers of absorbing material, may help lowering the total solar energy transmittance of the layer stack. According to an embodiment of the present invention, the sum of the geometrical thicknesses of the one or more layers of absorbing material ranges from 2 to 10 nm, preferably from 2 to 7 nm, more preferably from 2.5 to 5.5 nm. The inventors have found that too high absorbing layer thicknesses tend to degrade selectivity values, while too small thicknesses do not permit to lower LT sufficiently, in particular when the thermoplastic thermoplastic intercalating sheet (3) and/or inner glass sheets are not or less light absorbing.

According to an embodiment of the present invention, the layers of absorbing material may in particular comprise or consist of Nb, Ti, titanium nitride, niobium nitride, an alloy of Ni and Cr (NiCr alloy), or an alloy of Ni, Cr and W (NiCrW alloy) or a nitride of an alloy of Ni and Cr (NiCrN), or of an alloy of Ni, Cr and W (NiCrWN).

Absorbers TiN, NbN and Nb reach 1.0≤k≤2.0 for 1.5≤n≤4.5. More preferred absorbers of Ti, NiCr, nitride of NiCr and nitride of NiCrW reach 2.5≤k≤3.5 for 2.5≤n≤3.5, meaning that they are more efficient absorbers, with less impact on reflectance as less thickness is necessary to reach the desired absorption level. As is common in the art, n is the real part of the refractive index of a given material, while k is the imaginary part thereof. Here within, n and k are considered for a wavelength of 550 nm.

The absorbing material may consist of an alloy or nitride of an alloy of Ni, Cr and W (NiCrW alloy) and comprise from 30% to 90%, preferably from 40% to 70% and advantageously from 45% to 65% by weight of tungsten, and nickel and chromium in a nickel/chromium weight ratio of between 100/0 and 50/50, preferentially 80/20. The nitride NiCrWN of NiCrW alloy may comprise up to 20 wt % of nitrogen. NiCrWN may be formed unintentionally by nitrogen atmosphere leaking from nitride sputtering deposition up/downstream, to reach nitrogen weight % of up to 10%, preferably only up to 5%.

The absorbing material may consist of an alloy or nitride of an alloy of Ni and Cr in a Ni/Cr weight ratio of between 99/1 and 50/50, preferentially 80/20. The nitride NiCrN of NiCr alloy may comprise up to 20 wt % of nitrogen, preferably up to 10 weight %.

NiCrN and NiCrWN are particularly preferred absorbers, as the risk of reacting with any migrating species of oxygen or nitrogen during heat treatments is minimized.

In an embodiment of the present invention, the low emissivity coating (5) on the internal face of the laminated glazing, that is face number 4, may be characterized by an emissivity <0.30, advantageously <0.20, more advantageously <0.18, even more advantageously <0.15. Emissivity is measured according to the standard EN 12898:2001.

In an embodiment of the present invention, the low emissivity coating (5) on the internal face of the laminated glazing comprises at at least one functional layer comprising a transparent conductive oxide (TCO) layer or a metal nitride selected from the group consisting of titanium nitride, chromium nitride, niobium nitride, molybdenum nitride and hafnium nitride. Low emissive coatings based on such functional layers are particularly suitable as they are more durable than silver based low emissivity coatings.

In an embodiment of the present invention the at least one TCO layer comprises indium tin oxide, antimony-doped or fluorine-doped tin oxide, gallium- and/or aluminum-doped zinc oxide, mixed indium zinc oxide, vanadium oxide, tungsten and/or magnesium doped vanadium oxide, niobium-doped titanium oxide, and/or cadmium stannate.

Preferred transparent conductive oxide (TCO) may be selected from indium tin oxide, antimony-doped or fluorine-doped tin oxide and/or aluminum-doped zinc oxide (ZnO:Al) and/or gallium-doped zinc oxide (ZnO:Ga), with indium tin oxide or fluorine-doped tin oxide most preferred.

The refractive index of the material of the TCO functional layer is preferably 1.7 to 2.5.

The emissivity of the pane according to the invention can be influenced by the thickness of the functional layer of the low emissivity coating (5). The thickness of the at least one TCO layer may range of from 65 nm to 210 nm, preferably 90 nm to 175 nm, and most preferably 105 nm to 170 nm.

In a first low emissivity coating (5) comprising embodiment, the low emissivity coating (5) comprises, in sequence starting from the substrate surface:
a. An optional high refractive index layer, which may have a geometrical thickness ranging of from 7 to 23 nm, alternatively of from 8 to 20 nm, alternatively of from 9 to 19 nm
b. a first low refractive index layer, which may have a geometrical thickness ranging of from 18 to 55 nm, alternatively of from 20 to 50 nm, alternatively of from 25 to 45 nm, for example silicon oxide, and
c. a transparent conductive oxide layer, which may have a geometrical thickness ranging of from 75 to 210 nm, alternatively of from 90 to 175 nm, alternatively of from 105 to 170 nm, and
d. optionally
   i. a second high refractive index layer, which may have a thickness ranging of from 0 to 15 nm, alternatively of from 1 to 15 nm, alternatively of from 1 to 12 nm, for example a silicon nitride barrier layer,
   ii. a second low refractive index layer
e. and/or, optionally, a protective topcoat, which may have a thickness ranging of from 2 to 40 nm, alternatively of from 5 to 35 nm, alternatively of from 6 to 30 nm, and for example comprise silicon oxide with 5 to 40 mol % of zirconium.

Examples of high refractive index dielectric layers, that is, with a refractive index >1.7, alternatively >1.8, include zirconium doped titanium dioxide, silicon doped titanium dioxide, mixed oxide of zinc and tin, mixed oxide of titanium and silicon, silicon nitride.

Examples of low refractive index dielectric layers, that is, with a refractive index ≤1.6, alternatively ≤1.55, include silicon oxide, zirconium doped silicon oxide, mixed oxide of silicon and aluminum, magnesium fluoride.

Without any of the optional layers, low emissivity coating (5) allows to reach a light reflectance inside the vehicle, LRint <10% or even LRint <8%, while with the optional second high and low refractive index layers, light reflectance inside the vehicle, with values of LRint <4%, or LRint <3%, or even LRint <2% may be reached. The second high refractive index layer may in addition protect the TCO layer from degradation during bending or heat treatment. The protective topcoat allows for tuning the neutral color in reflection in combination with protection against scratches.

Typically, a pane of clear float glass (soda-lime glass) provided with an optional low emissivity coating (5) may have a light transmittance of LT ranging from 85% to 94%.

In a second low emissivity coating (5) comprising embodiment, the low emissivity coating (5) comprises the same layer sequence as the first low emissivity embodiment, except that the transparent conductive oxide which is replaced by an alternating sequence of n layers of transparent conductive oxide, with n>1, for example having each a thickness ranging from 20 to 80 nm, and n−1 intermediate layers of dielectric material, for example comprising silicon oxide, silicon nitride, zinc oxide, tin oxide, titanium oxide or alloys or mixtures thereof.

In a third low emissivity coating (5) comprising embodiment at least one functional layer comprises a metal nitride, a crystallinity-improving layer comprising ZrNₓ, wherein x is higher than 1.2 and at most 2.0, is present below and in contact with the metal nitride layer. The ratio of the thickness of the functional layer to the thickness of the crystallinity-improving layer may advantageously be from 5 to 10. The ratio of integrated intensity of a peak of the (111) plane to integrated intensity of a peak of the (200) plane in an X-ray diffraction pattern of the metal nitride contained in the functional layer may be higher than 2.5.

In an embodiment the metal nitride functional layer has an extinction coefficient of higher than 2.8 at a wavelength of 1500 nm.

In a fourth low emissivity coating (5) comprising embodiment the low emissivity coating (5) comprises in sequence starting from the substrate surface:
a. a first dielectric layer having a thickness of from 1.5 to 200 nm,
b. a first crystallinity-improving layer having a thickness of from 3 to 30 nm,
c. a first metal nitride functional layer having a thickness of from 3 to 60 nm, and
d. a second dielectric layer having a thickness of from 1.5 to 200 nm,
e. optionally followed by a second crystallinity-improving layer, a second metal nitride functional layer, and a third dielectric layer. wherein the crystallinity-improving layers comprise ZrNₓ, wherein x is higher than 1.2 and at most 2.0, and the metal nitride functional layers are selected from the group consisting of titanium nitride, chromium nitride, niobium nitride, molybdenum nitride and hafnium nitride and may have a thickness ranging from 3 to 60 nm and the first, second and/or third dielectric layers may have a thickness ranging from 1.5 to 2000 nm and advantageously comprise silicon nitride doped with aluminum.

In any embodiment of the present invention a metal nitride functional layer comprising low emissivity coating (5) may further comprise a toplayer comprising silicon dioxide, titanium nitride and/or carbon.

In any embodiment of the present invention, a metal nitride functional layer comprising low emissivity coating (5) may advantageously be deposited by magnetron sputtering, advantageously followed by a heat treatment at a temperature ranging from 400 to 700° C. for 2 to 60 minutes.

The outer and inner panes may independently be a glass sheet, or a plastic sheet comprising or consisting of poly(methyl meth) acrylate (PMMA), polycarbonates, polyethyleneterephthalate (PET), polyolefins, polyvinyl chloride (PVC), or mixtures thereof.

In most instances, at least one of the outer and inner panes is a glass substrate. It is however preferred that the outer and inner panes both be glass substrates.

The glass may be of any type, such as conventional float glass or flat glass, and may be of any composition having any optical properties, e.g., any value of visible transmission above 10%, ultraviolet transmission, infrared transmission, and/or total solar energy transmission.

The glass may thus be a glass of soda-lime-silica, aluminosilicate or borosilicate type, and the like. The glass composition typically comprises the following components (Comp. A). In all glass compositions described herein, the levels are expressed in weight percentage, or in weight ppm expressed with respect to the total weight of glass.

The glass may be a regular clear, colored or extra-clear (i.e. lower iron content and higher transmittance) glass substrate. Further examples of glass substrates include clear, green, bronze, or blue-green glass substrates. The laminated solar control glazing of the present invention may reach particularly low solar energy transmission even when one or both of the inner (4) and outer (1) glass panes are clear or extra-clear glass panes.

The typical composition of soda-lime-silicate-type glass (Comp. B) is as follows:

| | Comp. A | Comp. B |
|---|---|---|
| SiO₂ | 40-78% | 60-78 wt % |
| Al₂O₃ | 0-18% | 0-8 wt %, pref 0-6 wt % |
| B₂O₃ | 0-18% | 0-4 wt %, pref 0-1 wt % |
| Na₂O | 0-20% | 5-20 wt %, pref 10-20 wt % |
| CaO | 0-15% | 0-15 wt %, pref 5-15 wt % |
| MgO | 0-15% | 0-10 wt %, pref 0-8 wt % |
| K₂O | 0-15% | 0-12 wt %, pref 0-10% |
| BaO | 0-5% | 0-5 wt %, pref 0-1 wt %. |

In an advantageous embodiment, glass substrates for the outer glass pane (1) may be selected from clear or extra-clear soda-lime glass. It was found that such glass substrates, in that they limit light and solar energy absorption, make it easier for the solar control coating (2) to reach the high reflectance levels required by the present invention. These glass substrates typically have a light transmittance of at least 89% (measured at a glass sheet thickness of 4 mm). They may be qualified as colorless when looking through their main faces.

In the art, “ultra-white” or “extra-clear” or “low iron” glasses, these terms being used interchangeably here, are known since years in the solar or building domain, due to their high luminous and/or energy transmittance (at least 90% for a glass sheet thickness of 4 mm). These glasses contain low amount of iron such as 0.002-0.06% wt, preferably 0.002-0.04% wt, more preferably 0.002-0.02% wt of total iron (expressed as Fe₂O₃).

Examples of suitable clear soda-lime glass include those glass types having a high transmission in the infrared wavelength, obtained by the addition of specific oxidants such chromium oxide, cobalt oxide, selenium oxide, manganese oxide and/or cerium oxide to the base soda-lime composition. For example, a glass composition comprising, in a content expressed in percentages in total weight of glass: total iron (expressed as Fe₂O₃) at a level of 0.002-0.06% wt; and Cr₂O₃ at a level of 0.0001-0.06% wt, preferably 0.002 to 0.06% wt; or a glass composition comprising, in a content expressed in percentages in total weight of glass: 0.0015-1% wt of Cr₂O₃ and 0.0001-1% wt of Co; or a glass composition comprising, in a content expressed in percentages in total weight of glass: total iron (expressed as Fe₂O₃) at a level of 0.02-1% wt, preferably 0.06-1% wt, Cr₂O₃ at a level of 0.002-0.5% wt; and Co at a level of 0.0001-0.5% wt. Alternative solutions to obtain a low iron glass with a very high transmission in the infrared can use cerium oxide (0.001-1% wt) and/or a combination of known oxidant such as manganese (MnO from 0.01 to 1% wt), antimony (Sb₂O₃ from 0.01 to 1% wt), arsenic (As₂O₃ from 0.01 to 1% wt), and/or copper (CuO from 0.0002 to 0.1% wt). The composition may be selected such that the glass sheet is clear glass.

Further examples of suitable clear soda-lime glass include those which have been formulated to be easily chemically temperable—more favorable to ion exchange than conventional soda-lime-silica glass compositions while remaining easy to produce, in particular on an existing line of production of classical soda-lime-silica glass. Such glass composition may comprise the following components—Compositions C to E. Preferably, these glasses contain low amount of iron such as 0.0001-0.06% wt, preferably 0.002-0.04% wt, more preferably 0.002-0.02% wt of total iron (expressed as Fe₂O₃).

| Comp. C | Comp. D | Comp. E |
|---|---|---|
| 65 ≤ SiO₂ ≤ 78 wt % | 60 ≤ SiO₂ ≤ 78% | 65 ≤ SiO₂ ≤ 78 wt % |
| 5 ≤ Na₂O ≤ 20 wt % | 5 ≤ NaO ≤ 20% | 5 ≤ Na₂O ≤ 20 wt % |
| 0 ≤ K₂O < 5 wt % | 0.9 < K₂O ≤ 12% | 1 ≤ K₂O < 8 wt % |
| 1 ≤ Al₂O₃ < 6 wt %, | 4.9 ≤ Al₂O₃ ≤ 8% | 1 ≤ Al₂O₃ < 6 wt % |
| Preferably | | |
| 3 < Al₂O₃ ≤ 5% | | |
| 0 ≤ CaO < 4.5 wt % | 0.4 < CaO < 2% | 2 ≤ CaO < 10 wt % |
| 4 ≤ MgO ≤ 12 wt % | 4 < MgO ≤ 12% | 0 ≤ MgO ≤ 8 wt % |
| (MgO/(MgO + CaO)) ≥ | | K₂O/(K₂O + Na₂O): |
| 0.5, | | 0.1-0.7 |
| preferably | | |
| 0.88 ≤ [MgO/(MgO + | | |
| CaO)] < 1 | | |

Yet further examples of suitable clear soda-lime glass include those which have been formulated to provide high luminous transmittance as well as edges which are colorless/achromatic. Such glass composition may comprise the following components, in a content expressed in percentages in total weight of glass: 0.002-0.04% wt of total iron (expressed in the form of Fe₂O₃) at a redox ratio ≤32%, 0.003-0.1% wt of erbium (expressed in the form of Er₂O₃) and wherein: 1.3*Fe₂O₃≤Er₂O₃−21.87*Cr₂O₃−53.12*Co≤2.6*Fe₂O₃.

Another example of clear soda-lime glass composition may comprise the following components, in a content expressed in percentages in total weight of glass:
total iron (expressed as Fe₂O₃) at a level of 20-750 ppm;
Selenium (expressed as Se) at a level of 0.1-<3 ppm;
Cobalt (expressed as Co) at a level of 0.05-5 ppm; and
a ratio of Er₂O₃/Fe₂O₃ at a level of 0.1-1.5.

The glass may be annealed, tempered or heat strengthened glass.

The outer and inner panes may independently have a thickness ranging from 0.5 mm to 15 mm, alternatively from 0.5 mm to 10 mm, alternatively from 0.5 mm to 8 mm, alternatively from 0.5 mm to 6 mm. alternatively from 0.5 to 4 mm.

Both panes may have the same thickness, for example 0.5 mm, or 0.8 mm, or 1.2 mm, or 1.6 mm, or 2.1 mm, or 3 mm. Such symmetrical construction in glass thickness allows for ease of process and conventional sizing of the laminating process.

Both panes may also have different thicknesses, providing for asymmetrical laminated glazings, for example pane 1=0.5 mm and pane 2=2.1 mm, or pane 1=0.8 mm and pane 2=2.1 mm, or pane 1=0.5 mm and pane 2=1.6 mm, pane 1=0.8 mm and pane 2=1.6 mm, or pane 1=1.6 mm and pane 2=2.1 mm. Such asymmetrical constructions in glass thickness allow for flexibility in curvature, and/or in weight management and/or flexibility in light/solar modulation.

The terms “thermoplastic intercalating sheet” or “interlayer” as used herein, generally may designate a single-layer sheet or a multilayered thermoplastic intercalating sheet. A “single-layer sheet,” as the name implies, is a single or monolithic thermoplastic layer extruded as one layer which is then used to laminate two panes. A multilayered thermoplastic intercalating sheet, on the other hand, may comprise multiple layers, including separately extruded layers, co-extruded layers, or any combination of separately and co-extruded layers of thermoplastic material. Thus a multilayered thermoplastic intercalating sheet could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; a combination of at least one plural-layer sheet and at least one co-extruded sheet, or any other combination of sheets as desired.

The thermoplastic thermoplastic intercalating sheet (3) may thus be formed by one or a plurality of thermoplastic films.

The thermoplastic thermoplastic intercalating sheet (3) may comprise polyvinyl acetal, polyvinyl butyral, polyurethane, poly(ethylene-co-vinyl acetate), polyvinylchloride, poly(vinylchloride-co-methacrylate), polyethylenes, polyolefins, ethylene acrylate ester copolymers, poly(ethylene-co-butyl acrylate), silicone elastomers, epoxy resins, and acid copolymers.

The thermoplastic thermoplastic intercalating sheet (3) preferably comprises polyvinyl butyral (PVB), ethylene vinyl acetate (EVA), polyurethane (PU) and/or mixtures thereof and/or copolymers thereof, particularly preferably polyvinyl butyral.

The thermoplastic thermoplastic intercalating sheet (3) s are preferably based on the materials mentioned but can, however, contain other components, for example, plasticizers, photophores, heat insulating particles, infrared absorbing particles, polymer-dispersed liquid crystals, suspended particles, pigments, colorants, or UV absorbers, preferably with a content of less than 50%.

In order to characterize the optical properties of thermoplastic intercalating sheet (3) s, independently of the substrates and coatings present in the final laminated glazing, such optical measurements are typically performed on a reference laminated structure of two standard soda-lime clear glass substrates laminated with a given thickness of the thermoplastic intercalating sheet (3) to be characterized.

According to an embodiment of the present invention, the thermoplastic intercalating sheet (3) has a light transmittance, when provided in a thickness of 0.76 mm and when measured according to standard EN410:2011 with illuminant A/2° between two 2 mm thick normal clear glass sheets of not more than 90%/at least 1%.

According to an embodiment of the present invention, the thermoplastic intercalating sheet (3) has a solar energy absorption, when provided in a thickness of 0.76 mm and when measured according to standard EN410:2011 between two 2 mm thick normal clear glass sheets of not more than 50%/at least 3%.

According to an advantageous embodiment of the present invention, the thermoplastic intercalating sheet (3) has a light transmittance of not more than 90%/at least 42%, and a solar energy transmittance of not more than 45%/at least 10%, when measured according to standard EN410:2011 with illuminant A/2° between two 2 mm thick normal clear glass sheets

According to an advantageous embodiment of the present invention, the thermoplastic intercalating sheet (3) has a light transmittance of not more than 52%/at least 0.5%, and a solar energy absorption of not more than 90%/at least 50%, in particular the thermoplastic intercalating sheet (3) has a light transmittance of not more than 8%/at least 1%, and a solar energy transmittance of not more than 89%/at least 75% when measured according to standard EN410:2011 with illuminant A/2° between two 2 mm thick normal clear glass sheets.

The thermoplastic intercalating sheet (3) preferably have a thickness of about 0.2 mm to 1 mm, for example, 0.38 mm or 0.76 mm.

The present invention also relates to the use of the laminated solar control glazing according to the invention as a window pane of a vehicle.

The laminated solar control glazing according to the invention fulfills the high safety requirements in the vehicle sector. These requirements are typically checked by standardized fracture, impact and scratch tests, such as the ECE R43 ball drop test, well known to the skilled person.

The present laminated solar control glazing may particularly be used as a roof for a vehicle.

A vehicle includes those vehicles useful for transportation on road, in air, in and on water, in particular cars, busses, tramways, trains, ships, aircraft, spacecraft, space stations and other motor vehicles.

The window panes include rear windows, side windows, sun roofs, panoramic roofs or any other window useful for a car, or any glazing for any other transportation device, where light transmittance LT >70% is not a mandatory feature.

The window pane preferably is a roof panel of a vehicle, in particular a passenger car, as it may best provide for solar control over a wide surface as compared to side windows.

The present pane may be also be useful in architectural applications. Architectural applications include displays, windows, doors, partitions, shower panels, and the like.

In some instances, the laminated solar control glazing may serve as a heatable vehicle glazing.

### EXAMPLES

Different laminated glass configurations, LAM1 to LAM6, were used to evaluate the optical properties of the different solar control coating (2) examples. The outer glass is the glass destined to be in contact with the outside environment, the inner glass with the inner environment of an enclosure. The solar control coatings (2) are positioned in position 2, that is on the inwards facing side of the outer glass. The solar control coating (2) is in contact with the thermoplastic intercalating sheet (3). If present, a low emissivity coating (5) is positioned in position 4 (lowE pos4), that is on the inwards facing side of the inner glass. This lowE coating can be ITO (InSnOₓ) based and comprises typically a layer sequence, starting from the glass: TZO (14 nm)/SiO₂ (35 nm)/InSnOₓ (136 nm)/SiO₂ (77 nm)/SiZrOₓ (17 nm), having a normal emissivity of 0.15 in the examples below.

All layers in the coating may be deposited by magnetron sputtering on an industrial sputtering coater on soda lime glass substrates up to 3.21×6 m² in size.

TABLE 1
Laminated glass configurations

| | LAM1 | LAM2 | LAM3 | LAM4 | LAM5 | LAM6 |
|---|---|---|---|---|---|---|
| Outer glass | Normal | Normal | Normal | Normal | Normal | Normal |
| | clear, | clear, | clear, | clear, | clear, | clear, |
| | 2.1 mm | 2.1 mm | 2.1 mm | 2.1 mm | 2.1 mm | 2.1 mm |
| | thick | thick | thick | thick | thick | thick |
| Thermoplastic | Grey1.5, | Grey4, | Grey6, | Grey8, | Grey13, | Standard |
| intercalating | 0.76 mm | 0.76 mm | 0.76 mm | 0.76 mm | 0.76 mm | clear, |
| sheet (3), | thick | thick | thick | thick | thick | 0.76 mm |
| PVB | | | | | | thick |
| Inner glass | Normal | Normal | Normal | Normal | Normal | Normal |
| | clear, | clear, | clear, | clear, | clear, | clear, |
| | 2.1 mm | 2.1 mm | 2.1 mm | 2.1 mm | 2.1 mm | 2.1 mm |
| | thick | thick | thick | thick | thick | thick |

The polyvinylbutyral (PVB) thermoplastic intercalating sheet (3) s named Grey1.5, Grey4, Grey6, Grey8, Grey13 have a light transmittance of 1.5%, 4%, 6%, 8%, and 13% respectively.

Standard clear PVB is a PVB having a light transmittance of 84% or more. All PVB thermoplastic intercalating sheet (3) data is measured in accordance with EN 410 (2011)/ISO 9050 on laminated glass with 2 mm normal clear float glass/0.76 PVB/2 mm normal clear float glass.

Tables 2a and 2b show the layer stacks of different solar control coatings (2). REF is a typical solar control coating (2) used for example in laminated windshields. Examples 1 to 9 are solar control coatings (2) that have two silver functional layers and identical layer sequences, but different layer thicknesses. Example 10 is a solar control coating (2) having a single silver functional layer. Examples 11 to 14 show solar control coatings (2) having two silver functional layers and different layer sequences. The comparative example CEX is a coating for laminated glazings having a single silver functional layer.

TABLE 2a
Example layer stacks solar control - physical thicknesses in nm

| | | EX | EX | EX | EX | EX | EX | EX | EX | EX | EX |
|---|---|---|---|---|---|---|---|---|---|---|---|
| | REF | 1 | 2 | 3 | 4 | 5 | 6 | 7 | 8 | 9 | 10 |
| Glass | | | | | | | | | | | |
| ZSO | 16.5 | 73.9 | 65.0 | 7.3 | 0 | 36.0 | 33.9 | 32.9 | 17.7 | 22.0 | 55.8 |
| ZnO:Al | 10.0 | 10.0 | 10.0 | 10.0 | 8.0 | 10.0 | 10.0 | 10.0 | 10.0 | 10.0 | 10.0 |
| Ag | 9.2 | 21.3 | 22.4 | 5.2 | 5.0 | 9.6 | 24.6 | 8.4 | 10.1 | 9.9 | 19.8 |
| Ti barrier | 0.4 | 0.4 | 0.4 | 0.4 | 0.4 | 0.4 | 0.4 | 0.4 | 0.4 | 0.4 | |
| ZnO:Al | 1.0 | 1.0 | 1.0 | 1.0 | 1.0 | 1.0 | 1.0 | 1.0 | 1.0 | 1.0 | |
| ZSO | 77.0 | 89.0 | 79.0 | 65.8 | 84.0 | 101.9 | 103.2 | 91.1 | 84.8 | 95.0 | |
| ZnO:Al | 10.0 | 10.0 | 10.0 | 10.0 | 10.0 | 10.0 | 10.0 | 10.0 | 10.0 | 10.0 | |
| Ag | 13.1 | 8.6 | 7.3 | 20.6 | 24.5 | 25.9 | 10.3 | 23.4 | 28.7 | 26.0 | |
| Ti barrier | 0.4 | 0.4 | 0.4 | 0.4 | 0.4 | 0.4 | 0.4 | 0.4 | 0.4 | 2.3 | |
| ZnO:Al | 0.5 | 0.5 | 0.5 | 0.5 | 0.5 | 0.5 | 0.5 | 0.5 | 0.5 | 0.5 | |
| ZSO | 13.5 | 24.0 | 9.5 | 80.1 | 31.3 | 25.0 | 28.3 | 76.5 | 24.2 | 24.2 | 78.5 |
| TiO2 | 5.0 | 5.0 | 5.0 | 5.0 | 5.0 | 5.0 | 5.0 | 5.0 | 5.0 | 5.0 | 5.0 |

TABLE 2b
Example layer stacks solar control - physical thicknesses in nm

| EX11 | | EX12 | | EX13 | | EX14 | | CEX | |
|---|---|---|---|---|---|---|---|---|---|
| Glass | | Glass | | Glass | | Glass | | Glass | |
| ZSO | 22.0 | SiN | 10.0 | SiZrN | 13.0 | SiZrN | 13.0 | SiN | 63.0 |
| ZnO:Al | 10.0 | TiO₂ | 10.0 | TiO₂ | 7.5 | ZSO | 13.0 | NiCr | 3.0 |
| Ag | 9.9 | ZnO:Al | 10.0 | ZnO:Al | 10.0 | ZnO:Al | 6.0 | Ag | 19.0 |
| Ti barrier | 0.4 | Ag | 9.9 | Ag | 9.9 | NiCr | 0.5 | NiCr | 5.0 |
| | | | | | | barrier | | | |
| TiO₂ | 9.0 | NiCr | 0.9 | NiCr | 0.9 | Ag | 9.9 | SiN | 52.0 |
| | | barrier | | barrier | | | | | |
| ZSO | 85.0 | ZnO:Al | 11.0 | ZSO | 30.0 | ZnO:Al | 10.0 | | |
| ZnO:Al | 10.0 | ZSO | 84.5 | SiN | 29.0 | SiN | 60.0 | | |
| Ag | 26.0 | ZnO:Al | 11.0 | ZSO | 40.0 | ZSO | 30.0 | | |
| Ti barrier | 2.3 | Ag | 26.0 | ZnO:Al | 7.0 | ZnO:Al | 6.0 | | |
| ZnO:Al | 10.0 | NiCr | 0.9 | Ag | 26.0 | NiCr | 0.5 | | |
| | | barrier | | | | barrier | | | |
| SiN | 14.5 | ZnO:Al | 10.0 | NiCr | 0.9 | Ag | 26.0 | | |
| | | | | barrier | | | | | |
| | | SiN | 23.0 | ZSO | 10.0 | NiCr | 0.9 | | |
| | | | | | | barrier | | | |
| | | | | SiN | 16.0 | ZnO:Al | 8.0 | | |
| | | | | ZrO2 | 6.0 | SiZrN | 10.0 | | |
| | | | | | | SiN | 13.0 | | |
| | | | | | | TZO | 1.0 | | |

Layer materials used in examples
a. ZSO is a mixed oxide of tin and zinc, sputtered in an Ar-O₂ atmosphere from a metallic zinc-tin target with a zinc/tin weight ratio of 52/48.
b. ZnO:Al is aluminum doped zinc oxide deposited either from a metallic target of aluminum doped zinc 2 at % Al in an atmosphere of Ar and O₂; Alternately ZnO:Al may be deposited from a ceramic target of aluminum doped zinc oxide in an argon atmosphere.
c. Ti barrier is deposited as a metal from a Ti metal target in an Ar atmosphere directly on a silver functional layer. The Ti barrier is a sacrificial layer that is at least partially oxidized during the deposition of the subsequent oxide layer
d. NiCr barrier is deposited as a metal from a NiCr alloy target in an Ar atmosphere directly on a silver functional layer. The NiCr barrier is a sacrificial layer that is at least partially oxidized during the deposition of the subsequent oxide. NiCr here is an alloy with a Ni/Cr weight ratio of 80/20.
e. TiO₂, is a titanium oxide deposited in an Ar-O₂ atmosphere form a Ti metal target. The titanium oxide may be fully stoichiometric or alternately be sub-oxidized, noted TiOₓ with 1<x<2.
f. SiN is Si₃N₄ deposited from a metallic Si target, doped with aluminum, in an Ar atmosphere
g. SiZrN is a mixed nitride of silicon an zirconium with a Si/Zr ratio of 60/40 wt %.
h. TZO is a mixed oxide of titanium and zirconium having a TiO₂/ZrO₂ ratio of 65/35 wt %

Refractive indices for the above materials are as follows, at a wavelength of 550 nm:

| Material | n (@ 550 nm) |
|---|---|
| ZSO | 2.0 |
| ZnO:Al | 2.0 |
| TiO2 | 2.5 |
| SiN | 2.0 |
| SiZrN | 2.2 |
| TZO | 2.3 |

TABLE 3a
Optoenergetical properties, LAM6 configuration

| solar | | | | | | | | | | | | |
|---|---|---|---|---|---|---|---|---|---|---|---|---|
| control | | EX | EX | EX | EX | EX | EX | EX | EX | EX | EX | |
| coating (2) | REF | 1 | 2 | 3 | 4 | 5 | 6 | 7 | 8 | 9 | 10 | CEX |
| Config. | LAM6 | LAM6 | LAM6 | LAM6 | LAM6 | LAM6 | LAM6 | LAM6 | LAM6 | LAM6 | LAM6 | LAM6 |
| TE [%] | 43.8 | 27.8 | 28.4 | 29.0 | 27.3 | 25.1 | 26.3 | 26.1 | 21.9 | 24.5 | 38.6 | 15.2 |
| REext [%] | 35.3 | 56.1 | 55.0 | 52.0 | 54.2 | 56.5 | 58.5 | 55.7 | 59.7 | 54.3 | 51.0 | 44.4 |
| TL [%] | 75.0 | 47.3 | 47.6 | 48.7 | 47.2 | 45.8 | 46.1 | 46.3 | 45.1 | 47.4 | 51.9 | 24.4 |
| RLext [%] | 11.2 | 43.3 | 42.1 | 38.9 | 42.7 | 44.6 | 44.8 | 44.1 | 42.8 | 42.9 | 43.4 | 35.3 |
| g | 0.489 | 0.317 | 0.325 | 0.337 | 0.318 | 0.296 | 0.300 | 0.306 | 0.264 | 0.303 | 0.414 | 0.263 |

As can be seen from table 3a for the configuration LAM6, with solar control coatings (2) EX1 to EX10, an outside visible light reflectance RLext of over 35% is obtained and at the same time an external solar energy reflectance REext of more than 45%. At the same time, a light transmittance above 40% is obtained. With the reference solar control coating (2) REF, higher light transmittance is achieved, but total solar anergy transmittance g is too high. With the comparative example solar control coating (2) CEX, a low total solar energy transmittance is achieved, but visible light transmittance is too low for most building applications.

TABLE 3b
Optoenergetical properties, LAM 3 with lowE in position 4

| solar | | | | | | | | | | | |
|---|---|---|---|---|---|---|---|---|---|---|---|
| control | | EX | EX | EX | EX | EX | EX | EX | EX | EX | EX |
| coating (2) | REF | 1 | 2 | 3 | 4 | 5 | 6 | 7 | 8 | 9 | 10 |
| Config. | LAM 3 | LAM 3 | LAM 3 | LAM 3 | LAM 3 | LAM 3 | LAM 3 | LAM 3 | LAM 3 | LAM 3 | LAM 3 |
| | lowE | lowE | lowE | lowE | lowE | lowE | lowE | lowE | lowE | lowE | lowE |
| | pos4 | pos4 | pos4 | pos4 | pos4 | pos4 | pos4 | pos4 | pos4 | pos4 | pos4 |
| TE [%] | 4.8 | 3.1 | 2.9 | 3.4 | 3.0 | 2.6 | 2.8 | 2.9 | 1.9 | 2.5 | 5.2 |
| REext [%] | 34.1 | 57.10 | 54.6 | 51.5 | 53.7 | 56.1 | 58.1 | 55.3 | 59.4 | 55.7 | 51.0 |
| TL [%] | 5.2 | 3.2 | 3.3 | 3.4 | 3.2 | 3.2 | 3.2 | 3.2 | 3.1 | 3.2 | 3.4 |
| RLext [%] | 8.6 | 43.0 | 38.0 | 38.0 | 41.8 | 43.7 | 43.9 | 43.3 | 41.9 | 43.1 | 45.3 |
| g | 0.138 | 0.091 | 0.100 | 0.100 | 0.093 | 0.087 | 0.085 | 0.091 | 0.076 | 0.086 | 0.117 |

As can be seen from table 3b for the configuration LAM3 with a lowE in position 4, with solar control coatings (2) EX1 to EX10, an outside visible light reflectance RLext of over 35% is obtained and at the same time an external solar energy reflectance REext of more than 45%. At the same time, a light transmittance between 3 and 4% is obtained. The total solar energy transmittance is particularly low, reaching as low as 0.076. With the reference solar control coating (2) REF, somewhat higher light transmittance is achieved, and a significantly higher total solar anergy transmittance g is obtained. In table 3c, fir the same configuration, with solar control coatings (2) EX11 to EX14 an outside visible light reflectance RLext of over 35% is obtained and at the same time an external solar energy reflectance REext of more than 45%. At the same time, a light transmittance between 2 and 4% is obtained. The total solar energy transmittance is particularly low, reaching as low as 0.085. Comparative solar control coating (2) CEX does not reach as low total solar energy transmittance; even if the visible light reflectance is high. The solar energy reflectance is not high enough.

TABLE 3c
Optoenergetical properties

| solar control | | | | | |
|---|---|---|---|---|---|
| coating (2) | EX11 | EX12 | EX13 | EX14 | CEX |
| configuration | LAM3 | LAM3 | LAM3 | LAM3 | LAM3 |
| | lowE pos4 | lowE pos4 | lowE pos4 | lowE pos4 | lowE pos4 |
| ET | 2.5 | 2.0 | 2.1 | 1.8 | 1.8 |
| REext | 55.7 | 51.3 | 51.0 | 46.5 | 44.3 |
| TL | 3.1 | 2.9 | 2.8 | 2.4 | 1.7 |
| RLext | 44.1 | 43.7 | 43.3 | 43.2 | 35.0 |
| g | 0.085 | 0.088 | 0.089 | 0.094 | 0.111 |

TABLE 3d
Optoenergetical properties

| solar control | | | | | | | | | |
|---|---|---|---|---|---|---|---|---|---|
| coating (2) | REF | REF | REF | EX9 | EX9 | EX9 | CEX | CEX | CEX |
| configuration | LAM1 | LAM2 | LAM4 | LAM1 | LAM4 | LAM5 | LAM1 | LAM4 | LAM5 |
| | lowE | lowE | lowE | lowE | lowE | lowE | lowE | lowE | lowE |
| | pos4 | pos4 | pos4 | pos4 | pos4 | pos4 | pos4 | pos4 | pos4 |
| TE [%] | 1.7 | 3.4 | 5.0 | 0.8 | 2.7 | 3.9 | 0.8 | 2.1 | 2.9 |
| REext [%] | 38.5 | 38.5 | 38.5 | 53.9 | 53.9 | 53.9 | 44.3 | 44.3 | 44.3 |
| TL [%] | 1.3 | 3.6 | 6.1 | 0.8 | 3.8 | 5.9 | 0.4 | 2.0 | 3.1 |
| RLext [%] | 12.4 | 12.4 | 12.4 | 41.9 | 41.9 | 41.9 | 35.0 | 35.0 | 35.0 |
| g | 0.120 | 0.134 | 0.147 | 0.086 | 0.102 | 0.112 | 0.102 | 0.113 | 0.120 |

As can be seen from table 3c for each of the configurations LAM1, LAM2, and LAM4 with a lowE in position 4, the combination of high external visible light reflectance and high external solar energy reflectance gives significantly lower total solar energy transmittance values.

Thus a variety of solar control coatings (2) can be used in the laminated solar control glazings of the present invention. As can be seen in the numerous examples above, providing the laminated glazing with a sufficiently high external solar energy reflectance and visible light reflectance leads to significantly lower total solar energy transmittance levels than comparable when other solar control coatings (2) are used with which these reflectance levels are not reached.

1. A laminated solar control glazing comprising:
a. an outer glass pane and an inner glass pane, united by a thermoplastic intercalating sheet; and
b. a solar control coating applied to at least part of an inside face of the outer glass pane,
wherein, as result of the solar control coating an exterior visible light reflectance of the laminated solar control glazing RLext is at least 35% and an exterior solar energy reflectance of the laminated solar control glazing REext is at least 45%.

2. The laminated solar control glazing according to claim 1, wherein the laminated solar control glazing has a visible light transmittance LT of at least 40% and a total solar energy transmittance g of not more than 0.450.

3. The laminated solar control glazing according to claim 1, wherein the laminated solar control glazing has a visible light transmittance LT ranging from 1% to 10% and a total solar energy transmittance g of not more than 0.130.

4. The laminated solar control glazing according to claim 1, further comprising on an inner face of the second pane a low emissivity coating having an emissivity less than 0.300.

5. The laminated solar control glazing according to claim 1, wherein the inner and/or outer glass pane is heat strengthened, tempered or and/or bended.

6. The laminated solar control glazing according to claim 1, wherein RLext of the solar control glazing is at least 37%.

7. The laminated solar control glazing according to claim 1, wherein RLext of the solar control glazing is at most 70%.

8. (canceled)

9. (canceled)

10. The laminated solar control glazing according to claim 3, wherein TL of the solar control glazing is not more than 8%.

11. The laminated solar control glazing according to claim 3, wherein TL of the solar control glazing is at least 1%.

12. The laminated solar control glazing according to claim 3, wherein g is not more than 0.120.

13. The laminated solar control glazing according to claim 1, wherein the solar control coating comprises an alternating arrangement of n infrared radiation reflecting functional layers and n+1 dielectric coatings, with n≥1, such that each functional layer is surrounded by dielectric coatings.

14. (canceled)

15. The laminated solar control glazing according to claim 13, wherein the solar control coating comprises n=2 functional layers and comprises in sequence starting from the outer glass pane a first dielectric coating, a first functional layer, a second dielectric coating, a second functional layer and a third dielectric coating.

16. The laminated solar control glazing according to claim 15, wherein an optical thickness of the first dielectric coating is from 15 to 185 nm and/or in that an optical thickness of the second dielectric coating is from 140 to and 250 nm and/or in that an optical thickness of the third dielectric coating is from 30 to 200 nm.

17. The laminated solar control glazing according to claim 15, wherein a sum of the optical thicknesses of the first, second and third dielectric coatings is from 280 to 460 nm.

18. (canceled)

19. (canceled)

20. The laminated solar control glazing according to claim 13, wherein the solar control coating comprises one or more layers of absorbing material having extinction coefficients k such that 1.0≤k≤3.5 considered for a wavelength of 550 nm.

21. (canceled)

22. The laminated solar control glazing according to claim 1, wherein the at least one thermoplastic intercalating sheet comprises a material selected from the group consisting of polyvinyl acetal, polyvinyl butyral, polyurethane, poly(ethylene-co-vinyl acetate), polyvinylchloride, poly(vinylchloride-co-methylacrylate), polyethylenes, polyolefins, ethylene acrylate ester copolymers, poly(ethylene-co-butyl acrylate), silicone elastomers, epoxy resins, acid copolymers, polyvinyl butyral (PVB), ethylene vinyl acetate (EVA), polyurethane (PU) mixtures thereof, and copolymers thereof.

23. (canceled)

24. The laminated solar control glazing according to claim 1, wherein the thermoplastic intercalating sheet, measured when provided in a thickness of 0.76 mm between two 2 mm thick normal clear glass sheets, has a light transmittance ranging from 1% to 90%, or
a light transmittance ranging from 42% to 90% and a solar energy transmittance ranging from 10% to 45%, or
a light transmittance ranging from 0.5% to 52% and a solar energy absorption ranging from 50% to 90%.

25. (canceled)

26. (canceled)

27. The laminated solar control glazing according to claim 1, wherein the outer and/or inner glass pane is selected from clear or extra-clear soda-lime glass.

28. The laminated solar control glazing according to claim 4, wherein the low emissivity coating comprises at least one transparent conductive coating.

29. The laminated solar control glazing according to claim 28, wherein the at least one TCO coating comprises a material selected from the group consisting of indium tin oxide, antimony-doped or fluorine-doped tin oxide, gallium- and/or aluminum-doped zinc oxide, mixed indium zinc, vanadium oxide, tungsten and/or magnesium doped vanadium oxide, niobium-doped titanium oxide, cadmium stannate, and zinc stannate.

30. (canceled)
